(19) United States
(12) Patent Application Publication
(10) Pub. No.: US 2011/0283130 A1
(43) Pub. Date: Nov. 17, 2011

(54) Power control manager

(75) Inventors: Hong-Ren Pai, Hsinchu (TW); Shi-Hao Chen, Nantou City (TW)

(73) Assignee: Global Unichip Corporation

(21) Appl. No.: 12/800,516

(22) Filed: May 17, 2010

(51) Int. Cl. G06F 1/28; G06F 1/26

(52) U.S. Cl. 713/330; 713/340; 713/300

(57) ABSTRACT

An automatically configurable power control unit (PCU) is described that can be configured and used to satisfy requirements of different power domain of an integrated circuit. When implemented the PCU is automatically configured into a power control manager (PCM) along with other PCU's used with additional power domains in the integrated circuit. The PCM dispatches power on and off commands to each PCU contained within the PCM, schedules power on and off sequences amongst a plurality of PCU controlled by the PCM, blocks inappropriate power mode commands and monitors the state of each power domain coupled to the various PCU controlled by the PCM.

### BACKGROUND OF THE INVENTION

1. Field of Invention The present invention relates to power control circuitry and in particular to a power control architecture that is configurable and is used to automatically create power control for a wide range of integrated circuitry.

2. Description of Related Art

The development of integrated circuitry requires ancillary functions such a power and power control to be developed in support of the requirements of the circuitry. Each team of engineers are faced with the responsibility to develop these ancillary functions, which may be based in previously tried approaches. Special requirements may require new approaches, but a great amount of the development can be based on past proven circuitry.

U.S. Pat. No. 7,308,762 B2 (Waters et al.) is directed to an approach to algorithmic programming to system design in which the design is enabled, synthesized, structure validated to system-level specifications and integrated into the overall design process. U.S. Pat. No. 7,206,730 B2 (Pochayevets et al.) is directed to a configurable VHDL preprocessor in which statements are replaceable by specific values depending on design requirements. U.S. Pat. No. 7,035,781 B1 (Flake et al.) is directed to an HDL simulator having an automatic interface to compiled or interpreted application code written in general purpose language. In U.S. Pat. No. 6,701,501 B2 (Waters et al.) an algorithmic programming language approach is directed to system design, which enables design, synthesis, structure validation system-level specification and integrates the design into the overall design process. In U.S. Pat. No. 6,438,514 B1 (Hill et al.) a computer system is directed to operate to generate a system model from a set of instructions, which include a functional set of methods to which instructions are applied to a location of members of the model that represent the system model. U.S. Pat. No. 6,226,776 B1 (Panchul et al.) is directed to a computer aided hardware design system using high-level algorithmic programming language where the system converts the algorithmic representation of a hardware design into a hardware implementation.

U.S. Pat. No. 6,167,363 (Stapleton) is directed to a register transfer level (RTL) model that is created using an object-oriented programming language. In U.S. Pat. No. 6,053,947 (Parson) a method, apparatus and system is directed to simulating the operation of a circuit in which at least one signal is applied to one or more sub-circuit functions and executing the one or more signals through the sub-circuit functions. In U.S. Pat. No. 5,870,585 (Stapleton) a register transfer level model is directed to using an object oriented programming language in which logic circuits are represented by a hierarchy of objects each representing state elements, input and output signals, and internal signals. U.S. Pat. No. 5,546,562 (Patel) is directed to an emulation modeling apparatus comprising a device under stimulation and means for keeping the device under stimulation in a quiescent state to allow access to the emulation modeling apparatus without loss of data or functional accuracy. U.S. Pat. No. 5,600,579 (Steinmetz, Jr.) is directed to a hardware design verification system, which include a hardware simulator, test script, and dispatcher, wherein each run concurrent process on a computing system. U.S. Pat. No. 5,537,330 (Damiano et al.) is directed to a method used within a logic synthesis system to provide tags attached to nodes in a parse string to classify portions of a design as open control, structure dominant or direct map wherein the classification is used to determine the amount of optimization allowed during logic synthesis.

Instead of developing power control each time an integrated circuit is developed, a method to automatically generate power control using proven solutions to circuit requirements is needed. This would allow for less time involved in the development of power for integrated circuits and provide for more reliability. Special situations may still need the development of an individual power control circuit, but once done and proven this special requirement can be included in the library of possible power control circuits.

### SUMMARY OF THE INVENTION

It is an objective of the present invention to provide a power control methodology wherein a program control manager (PCM) containing one or more power control units (PCU) are controlled to provide power to one or more power domains.

It is further an objective of the present invention to automatically generate the PCU, automatically combine with additional power control units into the PCM and merge the PCM into an integrated circuit comprising a plurality of power domains.

It is still further an objective of the present invention to create the PCU by automatically configuring a configurable power control circuit to form the PCU.

It is also an objective of the present invention to control power-on and power-off from the PCM, which comprises translating a power mode command to dispatch power on and off commands to the PCU, schedule required sequencing of power commands, blocking inappropriate power mode commands and monitoring the state of each power domain containing integrated circuits.

In the present invention an automatically configured PCM is created that contains one or more automatically configured PCU. The PCM is automatically merged with an integrated circuit that is subdivided into one or more power domains. The power control to each power domain is directly controlled by a PCU, comprising power gating and issuing power status signal. The PCU is automatically configured circuit from a known reliable power circuit design. A separate power control manager PCM may be required to cover unique requirements of a power domain of the integrated circuit depending on the compatibility to the unique design of a PCU to the PCM that controls other PCU that are configured automatically.

The PCM translates power commands and dispatches power on and off commands to the PCU belonging to individual power domains. The PCM manages power sequencing of the various PCU, blocks inappropriate power mode commands and monitors the state of each power domain for proper power operation. The PCM is controlled by system firmware and software to control, for instance, power on or power off sequencing necessitated by powering up or powering down commands from a user of a system or system modes such as a sleep mode.

### BRIEF DESCRIPTION OF THE DRAWINGS

This invention will be described with reference to the accompanying drawings, wherein:

FIG. 1 is a block diagram of the power control functions of the present invention; and

FIG. 2 is a block diagram for creating a power control manager and power control units of the present invention.

### DETAILED DESCRIPTION OF THE PREFERRED EMBODIMENT

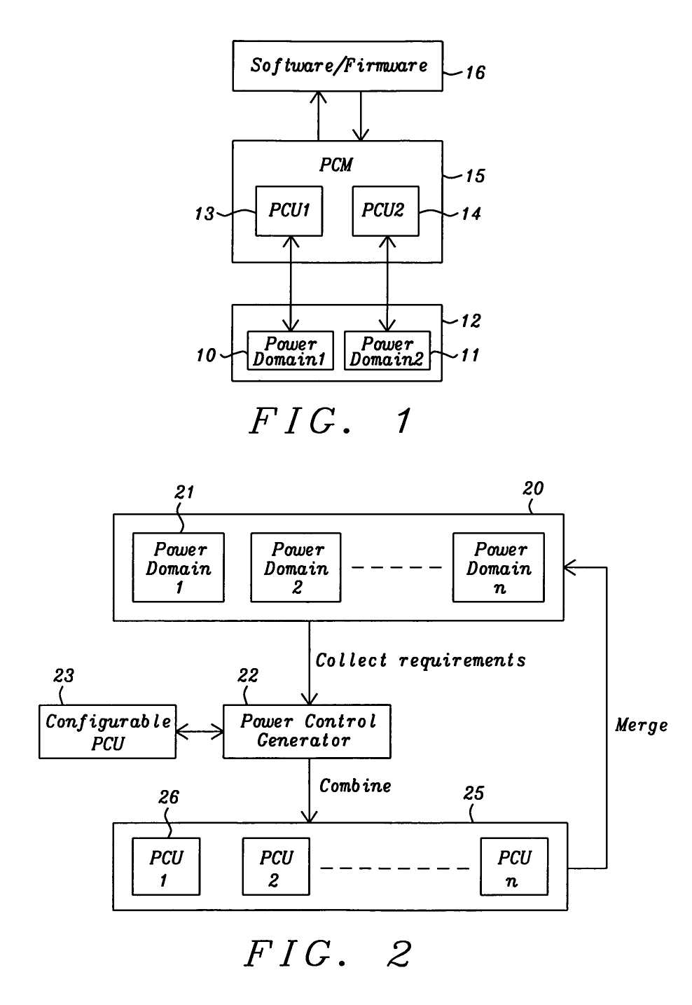

In FIG. 1 is shown the power control of the present invention. The design of the integrated circuits 12 requires two power domains 10 and 11 where the integrated circuitry is powered from two separate power control units PCU1 13 and PCU2 14. The power control units 13 and 14 control power gating to the integrated circuits to which they are coupled and issue power-on and power-off signals. The power control units are automatically configured and are controlled by a power control manager (PCM) 15. Special power control units may be required by the integrated circuitry and may not be automatically configured or compatible with the PCM 15. If special power control units are required to satisfy unique power requirements, an additional PCM to satisfy the power management requirements of the special power control units may be required. It is possible that the power control manager 15 could be compatible with the special power control unit; and therefore, the PCM 15 could be used in addition to PCU1 and PCU2. It should be understood that the number of power control units that are controlled by the PCM 15 is not limited to the two shown in FIG. 1.

The PCM 15 translates power mode commands and dispatches to PCU1 and PCU2 power-on and power-off commands. The PCU 15 schedules proper power-on and power-off sequences and clock gating to insure circuitry included in the power domains 10 and 11 are powered off or powered on properly. The PCM blocks power mode commands that are inappropriate and monitors the state of each power domain 10 and 12 that are being serviced by the power control units 13 and 14 that are controlled by the PCM 15.

Software and/or firmware 16 provides power mode commands to the PCM 15 which comprises power-up, power-down, enter sleep mode and exit sleep mode. The PCM 15 provides feedback of the status of the power domains 10 and 11 to the software or firmware 16 that initiate the power mode commands, and the PCM blocks inappropriate power mode commands that are made from the software or firmware.

In FIG. 2 is shown a block diagram for creating power control for an integrated circuit 20. The integrated circuit 20 comprises a number of power domains 21 ranging from power domain 1 through power domain n. The requirements of each power domain 21 are coupled to a power control generator 22. The power control generator 22 applies the requirements of each power domain 21 to a configurable power control unit (PCU) 23 and creates a power control unit 26 for each power domain 21 of the integrated circuit, wherein PCU1 is the power control unit for power domain 1, PCU 2 is the power control unit for power domain 2 and PCUn is the power control unit for power domain n. Each of the power control units 26 form a part of a power control manager (PCM) 25. The PCM 25 and the associated power control units 26 are integrated with and connected to the corresponding power domains 21.

The power control generator 22 using a configurable PCU 23 with a proven reliable power circuit configuration configures each power control unit 26. Requirements are coupled to the power control generator 22 from the power domains to automatically create each power control unit 26. These requirements comprise the number of power modes, the number of power domains, power domain mapping rules, need for sequencing and clock gating, and voltage and current requirements. The configured power control units 26 and requirement information for the power domains 21, are combined to create a PCM 25, and the PCM 25 containing the power control units 26 is merged into the integrated circuit design 20.

While the invention has been particularly shown and described with reference to preferred embodiments thereof, it will be understood by those skilled in the art that various changes in form and details may be made without departing from the spirit and scope of the invention.

What is claimed is:

1. A configurable power control for integrated circuits, comprising:
a) an integrated circuit design with one or more power domains;
b) a configurable power control unit;
c) a set of specifications for each of said one or more power domains; and
d) said set of specifications coupled to a power control generator, whereby said power control generator creates automatically a power control unit (PCU) for each of said one or more power domains.

2. The configurable power control of claim 1, wherein said PCU forms a part of a power control manager (PCM) that controls the power requirements of said one or more power domains.

3. The configurable power control of claim 2, wherein said PCM controls power-on and power-off of the one or more power domains on an integrated circuit.

4. The configurable power control of claim 1, wherein said power control generator uses proven designs to configure the PCU.

5. A method to automatically configure power control for integrated circuits, comprising:
a) specifying power requirements of a power domain of an integrated circuit;
b) applying said power requirements of said power domain to a power control circuit generator;
c) generating a power control unit (PCU) for said power domain;
d) using said PCU to form a part of a power control manager (PCM); and
e) controlling power to said power domain with said PCM.

6. The method of claim 5, wherein said PCM translates power commands, which further comprise:
a) dispatching power on and off to said PCU;
b) scheduling a correct power on and off sequence amongst a plurality of said PCU;
c) blocking an inappropriate power mode command; and
d) monitoring a state of said power domain for each said plurality of said PCU.

7. The method of claim 6, wherein said PCU is used for controlling power gating and issuing a power switch signal to the power domain to which the PCU is coupled.

8. The method of claim 6, wherein said PCU is a power circuit design in which the design is configurable to control power requirements of additional power domains to control power gating and to issue said power switch signal.

9. An automatically configured power control, comprising:
a) a means for collecting power requirements of an integrated circuit;
b) a means for automatically configuring power control units;
c) a means for automatically creating a power control manager; and
d) a means for automatically merging said power control manager into said integrated circuit.

10. The automatically configured power control of claim 9, wherein said means for collecting power requirements, further comprises extracting from the integrated circuit design:
a) number of power domains;
b) number of power modes;
c) mapping rules of said power domains and said power modes;
d) voltage and current requirements; and
d) clock gating and sequencing requirements.

11. The automatically configured power control of claim 9, wherein said means for automatically configuring power control units combines a configurable power circuit with said power requirements using a power control generator.

12. The automatically configured power control of claim 9, wherein said means for automatically creating said power control manager comprises combining said power control units into a framework of said power control manager.

13. The automatically configured power control of claim 9, wherein said means for automatically merging said power control manager into said integrated circuit comprises the use of mapping rules for power domains and power modes of said integrated circuit.
